(19) United States
(12) Patent Application Publication
(10) Pub. No.: US 2017/0034366 A1
(43) Pub. Date: Feb. 2, 2017

(54) Method for Electronically and Physically Archiving Documents

(71) Applicant: Fileee GmbH, Muenster (DE)

(72) Inventors: Eike Thies, Muenster (DE); Arne Oliver Osthues, Muenster (DE); Marius Gerwinn, Muenster (DE)

(21) Appl. No.: 15/303,297

(22) PCT Filed: Mar. 13, 2015
(86) PCT No.: PCT/EP2015/055374

§ 371 Date: Oct. 11, 2016

(30) Foreign Application Priority Data
Apr. 11, 2014 (DE) 10 2014 105 183.1

(51) Int. Cl. H04N 1/00; G06K 9/00; G06F 17/30

(52) U.S. Cl. CPC H04N 1/00148; G06F 17/30073; G06F 17/30011; H04N 1/00172; H04N 1/00251; G06K 9/00456; H04N 2201/0422; H04N 2201/0428; G06K 2209/01; G06K 2209/27

(57) ABSTRACT

The present invention describes a method for electronically and physically archiving documents, said method having the following steps:
a) producing a file by a recording a digital image of the physical document using a camera;
b) storing at least some information based on the file captured in step a) in an electronic memory;
c) filing the captured physical document in a container or in one of a number of containers provided for the physical filing of the documents to be archived;
d) linking a unique container identification and/or position information of the physical document in the container with the file produced in step a) and/or the information stored in an electronic memory in step b), and
e) storing, in a database, the file produced in step a) and/or the information stored in an electronic memory in step b) with the link obtained in step d).

The present invention also describes a container for carrying out the method according to the invention and also a computer program associated with the method, and an electronic data storage medium.

The present invention relates to a method for electronically and physically archiving documents. The present invention also describes a container for carrying out a method, and also an electronic data storage medium or electronic memory comprising a computer program for executing a method. The present invention also relates to a method for finding physical documents.

Many documents should be stored for a relatively long period of time since important rights are associated therewith. These documents include, among others, invoices, insurance documents, payslips, account statements, tax returns, warranty documents, contracts, etc. Some of these documents must be stored for legal reasons for up to 10 years. This is true in particular for documents that are essential for tax or accounting purposes. The archiving of physical documents is associated with a relatively large amount of work, because the documents must be sorted and filed away. Here, a strict organization must be observed, because otherwise it is very difficult to find the document. In addition, in order to find a document, the organizing principle must be known. Therefore, more recently, documents are electronically captured and stored in databases. This makes it possible to search the documents on the basis of any criteria. For many purposes an electronic copy is sufficient for this. However, in some cases original documents are required. This is true in particular for documents for which there is an obligation to retain. Furthermore, original documents are required when claiming guarantees or warranties. For these purposes, audit-compliant database systems can be used. However, these systems are very expensive and require good maintenance by backup files, and therefore audit-compliant databases are generally used in larger companies. For smaller craft and trade businesses or private users, these systems are too complex.

In view of the prior art, one object of the present invention is therefore to provide a technically improved method for the archiving of documents, which method is not afflicted by the disadvantages of conventional methods.

In particular, the method should enable good archiving without complex sorting of the documents. Furthermore, the method should be as simple and economical as possible. In particular, the use of an audit-compliant database system should not be absolutely necessary. A further object can be considered that of providing an archive which can be searched on the basis of any criteria in order to physically find a document. Furthermore, a method for finding physical documents that have been archived should be provided, said method being particularly simple, quick, and reliable.

These objects as well as further objects not explicitly mentioned, but which can be easily derived or deduced from the contexts discussed herein in the introduction are achieved by a method for electronically and physically archiving documents having all the features of claim 1.

The subject of the present invention is accordingly a method for electronically and physically archiving documents, said method comprising the following steps:

a) producing a file by recording a digital image of the physical document using a camera;

b) storing at least some information based on the file captured in step a) in an electronic memory;

c) filing the captured physical document in a container or in one of a number of containers provided for the physical filing of the documents to be archived;

d) linking a unique container identification and/or position information of the physical document in the container with the file produced in step a) and/or the information stored in an electronic memory in step b), and

e) storing, in a database, the file produced in step a) and/or the information stored in an electronic memory in step b) with the link obtained in step d).

Furthermore, the present invention provides a method for finding documents, in particular physical documents, which have been archived in accordance with the aforementioned method.

As a result of the present invention, in particular a very quick, timesaving archiving of a physical document can be achieved, since in particular no specific organization is necessary with regard to the filing, and instead a simple stack in a container is produced. Furthermore, a physical document can be easily found as required without having to undertake a strict sorting when filing the physical document. In addition, a document can be easily found on the basis of criteria which are only relevant at the time of the search, that is to say much later than the time of archiving. The method can be carried out very easily and simply, and therefore there is no need for any extensive training time. The method can also be carried out without audit-compliant systems, which involve a high maintenance and installation effort. Standardized components, which can be obtained economically, can be used to carry out the method.

The present invention is based on the finding that a link between a piece of position information for a physical document in a container and an associated electronic document in a database can combine the advantages of an audit-compliant electronic archive with those of a conventional archive based on paper documents. On the whole, a system based on file folders can therefore be replaced. As a result, very high costs and a high expenditure of time can be saved.

Within the scope of the present invention, the term “physical document” or “physical archiving” is understood in particular to mean a written document or filing thereof in physical form, i.e. for example as a printout or as a paper document. An electronic document can be considered to be a file which can be read by electronic systems, wherein the information stored in the file contains at least some of the information that can be extracted from the physical document.

In a first step of the present archiving method, a file is produced by recording a digital image of the physical document using a camera. Accordingly, a photograph of at least part of the physical document is produced. This digital image can be created here in any arbitrary format, for example jpeg, gif, pdp, png, raw, tiff, wmf, etc, and can be stored in step b), at least in part as appropriate.

Here, the physical document can be photographed in full. Here, an examination or auxiliary function provided by software can be used, which function is based for example on an underlay that can be used in conjunction with the container and that has a high contrast in relation to the photographed document. This examination or auxiliary function can thus in particular output a warning if the produced electronic file or the object to be photographed does not have a peripheral edge based on the support surface with the high contrast (edge recognition). Furthermore, the examination or auxiliary function can use sensors, which are provided in the camera as necessary, in order to improve the quality of the image or advise the user of images of which the quality does not meet conventional requirements. By way of example, the data of brightness sensors can thus be used in order to advise the user that an additional light source is expedient. Furthermore, the data of an acceleration sensor can be used in order to prompt the user by way of example to place the camera on an appropriate device and then automatically actuate the shutter release of the camera if the equipment is not moved within a certain period of time. Furthermore, OCR software can be used as a module of the examination or auxiliary function. By way of example, it is possible to query by means of this module whether values have been fully detected. Furthermore, it is possible to check by means of artificial intelligence whether or not at least one anticipated term contained generally in the documents to be archived has been detected. These anticipated terms include, for example, meta-information, in particular keywords. These include, among others, keywords such as tax, invoice, insurance, certificate, reminder, notice. If none of the predefined keywords is found, a warning can likewise be output. The warning can be output for example by a visual or mechanical display, which will be described in particular in conjunction with preferred embodiments of the camera or other parts of the archiving system.

This warning function can be implemented in full or in part by software in the camera. In accordance with a particular aspect, it is possible to check by way of example whether the light conditions are expected to provide sufficient image quality or whether the image has a sufficient contrast. A pattern recognition, in particular an edge or frame recognition, can also be provided, which checks whether the document is located at a favorable distance from the camera.

In this context, it is possible to check in particular whether the shape of a rectangle meeting predefined conditions has been detected. By way of example, it can be predefined that the detected rectangle should occupy at least 45% of the overall area of the recorded image. It can also be predefined that the detected corner points of the rectangle should be distanced 20% at most from one of the screen edges. Should at least one of these conditions not be met, a warning that the camera should be brought closer to the document can be displayed to the user. If no rectangle is detected, a warning that the camera should be moved further away from the object or that no document has been detected can be displayed, for example.

The warning function realized in the camera allows in particular a real-time display of a warning so that the user receives a notification straightaway and can immediately produce a new, improved recording of the physical document. By way of example, the user can be requested, by means of a warning or auxiliary function, to move closer to the document or to provide a greater distance between the camera and document.

The brightness values can be evaluated by statistical classification methods. Generally, brightness values in a range from 0 to 255 can be predefined in a digital image, for example. In order to evaluate a sufficient brightness, it can be predefined for example that the standard deviation of this brightness across the pixel values present is less than 100, the brightness value is less than 180, and the darkest pixel in the image has a value below 20. If these conditions are not met individually or as a whole, the user can be advised accordingly to provide an appropriate light source.

This warning function can be provided preferably by a computer system, to which the camera transmits the image data generated in step a) and/or the information obtained in step b). In this case, the computer system, which is preferably connected wirelessly or directly to the camera, can generate for example a report regarding the performed archiving of a document or a status message in which the warnings are presented where applicable. This report and/or this status message can be presented to the user where applicable, on a desktop computer or on the camera, preferably a smartphone, in the form of a message, for example by e-mail. The advantages of a computer system connected to the camera, said computer system being installed independently of the camera, include, among others, easier securing of critical data via backup systems and easier maintenance for different users. Furthermore, the camera can be used with simpler and relatively less powerful hardware, since tasks requiring high processing effort can be performed by the computer system.

By way of example, a user can receive a warning if the image contains too little text, wherein, where applicable, the number of letters can be set as a default via a statistical analysis expedient for the user. Furthermore, the user can be presented with a warning if predefined information has not been recognized, for example sender information. By way of example, the user can thus input missing information manually into the database.

In accordance with a preferred embodiment, some of the auxiliary or warning functions can be realized in the camera, and some of these functions can be realized by a computer system connected to the camera.

The camera used to carry out step a) can be a digital camera, a smartphone with camera, a tablet with camera, or a scanner, wherein a mobile device, preferably a smartphone with a camera, is preferably used.

In step b) at least some of the information based on the file captured in step a) is stored in an electronic memory. The digital camera used in step a) generally produces a file which is preferably filed in a non-volatile electronic memory. This file preferably contains all information of the physical document expedient to further processing. Depending on the needs and requirements of the user, a suitably high resolution of the file obtained in step a) representing a digital photograph of the physical document is selected for this purpose. In this context, the previously described warning or auxiliary function based on an OCR module can be used so that a detection of particularly relevant information can be ensured. It is thus ensured in particular, by means of step b), that information relevant to the user is transferred into a memory, wherein this information is provided for further processing. Depending on requirements, the file obtained in step a) by way of example can be converted into pure text by an OCR module, which text is then further processed, without a digital photograph being stored. In an advantageous embodiment the file obtained in step a) is stored. This storage can be in a volatile or a non-volatile memory, wherein a non-volatile memory is preferably used. A non-volatile memory is understood here in particular to mean a memory, of which the information cannot be lost, not even in the event of separation from the power circuit. Furthermore, the storage in accordance with step b) of at least some information based on the file captured in step a) can be in a memory located in the camera, or can be in a memory provided in a computer connected to the camera. This computer can be a server managed by the user or a computer controlled and maintained by a provider and for example can be connected to the camera via the Internet.

The components necessary and preferred in order to carry out the previously described steps a) and b) are well known, wherein appropriate cameras, text recognition (OCR or optical character recognition) modules and memories are commercially available. Here, methods, in particular algorithms for improving the image quality or image segmentation, or what are known as image-processing methods, can be used with preference, wherein, in addition to standard algorithms, cutting-edge methods can also be used. By way of example, simple methods such as a Gaussian blur can be used initially for edge recognition in order to prepare the image. In addition, conventional edge detection algorithms, such as Canny or Sobel, can be used in order to highlight edges. A binarization in the form of local or adaptive threshold methods can also be used, such as an analysis of related pixels, in order to analytically determine the final contours of objects in the image. In order to find the contour which in all likelihood is to be assigned to the greatest extent to the document, selection criteria can be used in order to rule out small contours or contours that are not relevant because they do not lie in the middle of the image. Furthermore, methods for transposing image information between two geometry spaces can be used in order to extrapolate from this any distortion of the detected document. Lastly, it is possible, in particular by morphological operations and histogram modifications, such as stretching or compression, to remove undesirable image information and to separate the foreground (text) and background (paper, document) from one another better and much more clearly. By selecting suitably sized reference quantities (sometimes also referred to as brush size or filter size) at the time of the morphological operations, it is possible to filter out shading, blemishes and other image defects, and at the same time soft and legible text can be obtained.

Furthermore, provision can be made to use what are known as super resolution algorithms in order to create a new image from a number of recorded images of constant resolution and quality, said new image having an improved and sharper level of detail compared with each of the individual recorded images. Here, use is made in particular of the fact that each individual image has a different noise behaviour and thus differs minimally from each other image. By combining the image information, the system-induced noise can be eliminated. In addition, areas can be repaired by means of image patching by querying an image database containing existing or known image patterns and incorporating the image replacement components available for this purpose, which have an improved resolution.

In step c) the physical document captured in step a) is filed in a container or in one of a number of containers provided for the physical filing of the documents to be archived. These containers are not subject to any particular limitations, and therefore the size and material from which the container is made can be adapted to the current requirements. For cost reasons, the container can be made primarily of cardboard, for example. The container is preferably provided with an identifying mark stored in a database or a database system, which mark is used for the electronic archiving of the documents. Preferred embodiments of the container will be described later.

In accordance with the invention, the file produced in step a) and/or the information stored in an electronic memory in step b) is/are linked to a unique container identification and/or position information item of the physical document in the container.

A unique container identification can be generated here automatically by the system upon creation of a database in which the electronic documents are filed. Furthermore, the user can create a unique container identification by means of an input. In accordance with a preferred embodiment the container can be provided with a unique identification feature which can be read using a camera, preferably via a communications interface. Further details regarding identification features and communications interfaces that can be used expediently will be discussed later.

The position information can result preferably from the time of filing of the physical document, in particular from the documents previously filed in the container. The position information is preferably a piece of information which is to be considered in respect of the position of further physical documents already filed previously or that will be filed at a later moment in time. Generally, a stack is formed in the container, wherein the relative position of a filed physical document can be derived from the number of documents filed beforehand and subsequently. In order to derive this position, an average paper weight of, for example, 70 g/m², 80 g/m², 90 g/m² or 100 g/m², can be assumed. Furthermore, when filing a document, the number of pages of said document can be queried. This may be expedient in particular if, for the archiving of a physical document having a number of pages, an electronic archiving of one of these pages or a small number of these pages is sufficient. This can be the case for example with comprehensive insurance policy documents, in which case the information necessary for electronic archiving is contained on the first page, whereas standard clauses are specified on the subsequent pages.

In step d) a unique container identification is preferably linked with the file generated in step a) and/or the information stored in an electronic memory in step b), wherein a link between a unique container identification and a piece of position information for the physical document in the container are particularly preferred.

In step e) the file produced in step a) and/or the information stored in an electronic memory in step b) is/are stored in a database with the link obtained in step d). Here, the file produced in step a) and/or the information stored in an electronic memory in step b) can be rewritten into another area of a memory. Furthermore, provision can already be made in step a) or b) for the data to be written into a database so that in step e) only the link obtained in step d) is stored in the database.

A database generally comprises software for the management of data, usually referred to as a database management system, and also the data to be managed, which will also be referred to herein as a data pool. Here, these functions, depending on the specific embodiment, can be implemented in a mobile computer system, for example a smartphone or a tablet. These functions can preferably be realized at least in part by a networked computer system, which particularly preferably can be connected to the camera via the Internet.

In a particularly preferred embodiment, the data stored on the camera or a computer connected locally to the camera can be synchronized, preferably via the Internet, with a larger computer system, preferably organized over a wider area. As a result of this embodiment, a high level of data security can be obtained, since the data available in the Internet can be centrally secured, wherein older versions of the database, in particular of the data pool, can also be electronically stored. These backup copies allow the database to be restored as necessary. This is important in particular in the event of loss or damage of the camera. These advantages can be attained, among others, in that the camera establishes a wireless connection to the Internet, for example via W-Lan or mobile communication.

Furthermore, the use of a larger computer system preferably organized over a wider area, enables the allocation of various containers, which can be filled by a number of users, to an organization that operates over a wider area. Furthermore, as a result of the use of a decentralized computer system, a specific container associated with a certain container identification can be filled by a number of users with use of different cameras, in particular smartphones, without the obtained physical archive being inconsistent.

In addition, the use of computer systems organized over a wider area allows the recovery of statistical information over a number of groups. By way of example, if various users can process documents by a text recognition system organized over a wider area, the recognition quality can be improved, since a broader statistical basis can be provided.

The execution of the method can be facilitated, inter alia, in that the camera establishes a wireless connection to an electronic device for triggering the camera, wherein the electronic device is preferably attached to the particular container. Here, the term ‘electronic device’ is to be understood comprehensively. It is important that, by means of the electronic device, an automatic operation of the camera can be caused, going beyond the direct input of the user. Accordingly, the electronic device can be considered as a communications interface, by means of which the camera is connected to the container. The electronic device attached to or mounted on the container can be provided for example by radio technology, wherein models known for this purpose, such as NFC, RFID, Bluetooth, preferably Bluetooth-Low-Energy, or W-Lan, can be used. Furthermore, the container can be provided with sensors, in particular pressure, brightness, acceleration, or acoustic sensors, which trigger an application, in particular a computer program, to carry out the method according to the invention. An electronic device for triggering the camera can be attached here at a suitable point of the container. The above-presented sensors can preferably be provided on an attachment for supporting the camera.

Furthermore, coded fields, in particular in the form of barcodes and/or QR codes, can be provided on the container in order to simplify the operation of the system or hinder operator errors. These coded fields, for example the QR codes, are preferably applied to a support surface region on which the documents are to be placed and recorded by the camera. A photographing of these coded fields may thus lead to a transmission of information to a program provided on the camera. By way of example, a container identification can be transmitted in this way. This technology is supported by all smartphone operating systems, wherein corresponding APIs are provided or obtainable for software developers.

Furthermore, provision can be made for a number of physical documents to be archived with production of a file, wherein each file is linked to an identifier and is stored in the database, wherein the identifier is produced by an input of a user, by evaluation of text recognition of the file and/or by an intelligent allocation on the basis of other information.

The structure of the database, in particular the data pool, is not critical per se and can be adapted to the needs of the user. The database, in particular the data pool, can preferably store the data in a superordinate manner, said hereinafter to be global. Here, the information concerning the documents archived in a container is stored as reference in particular. Furthermore, this global database, in particular the global data pool, comprises information concerning the container used by the one or more users, in particular a container identification, which is preferably unique for a system. At least some of this information, preferably a container identification, can preferably be extracted via a coded field, in particular a barcode or a QR code, mounted on a container. Furthermore, a container can be allocated a name predefined by the user. Provision can be made preferably for the number of pages of a document to be stored in the global database, in particular the global data pool. Furthermore, all data necessary for calculating the height of a document in the stack in a box can be stored in the global database, in particular the global data pool. As a result of this embodiment, a surprising increase in the performance of the system can be attained. The global database, in particular the global data pool, can preferably be stored in the temporary memory of a computer.

In a further embodiment, provision can be made for the global database to constitute a NoSQL (Not only SQL) database, wherein the term NoSQL means that the database not only allows SQL access, as proposed, inter alia, by Eric Evans 2009. As a result of this embodiment, the database can be very effectively extended and supplemented without the need for a complete re-organization of the data.

This makes it possible to further develop the algorithms for the height calculation of the aforementioned position display during running operation, as necessary.

More detailed information concerning the documents contained in a container and which can be referenced in a global database, in particular a global data pool, can preferably be stored in a further database, in particular a further data pool. Various datasets can be created for this purpose, which are each related to one another via references. Metadata relating to a document can preferably be contained in a dataset. This metadata in particular comprises terms and information that are used for searches and that enable access to the database. It includes in particular categories or types of documents evident from the document itself, for example tax, invoice, insurance, certificate, reminder, notice, or which can be predefined explicitly by the user. This dataset comprising the metadata can also contain a reference to the container in which the document is physically filed. Information obtained by use of text recognition software can be stored in a further dataset so that the text contained in a document can be stored in a dataset. The image information of a document can be stored in a further dataset. As a result of this embodiment, the data stock of an archive can be searched particularly easily and simply, wherein even relatively weak hardware is sufficient to find the documents. In particular, not all data of all documents has to be held available in the temporary memory, but instead, as necessary, can be loaded into the temporary memory and deleted again from the temporary memory following the search. Provision can be made preferably for the images to be stored in compressed form, preferably for example in jpg or png format. Furthermore, this embodiment has the advantage, when deleting a document, of removing the information from the data stock of the database, but physically leaving the documents in the container, wherein in this case empty sheets are stored in the system in order to thus be able to calculate the position of the physical documents in correct form, wherein more detailed explanations in this respect have been discussed above or will be discussed further below. Provision can be made preferably for the information stored in the database, in particular the image information, to be encrypted, wherein an individual key can be provided particularly preferably. An individual key can be provided particularly preferably for each container.

In order to carry out the method, a user or a user community can use a number of containers. This can be the case for example if documents are to be pre-sorted into groups. By way of example, one container can be provided for incoming invoices, whereas a further container is reserved for contracts, etc. Furthermore, various containers can be used to uniformly archive documents sent to various branches of a company or residences of an individual. In this case, an identification feature provided on the container and which can be automatically detected by the used camera, possibly in cooperation with further components of the archiving system, facilitates operation by the user so that errors can be avoided.

A further subject of the present invention is a method for finding a physical document, which method is characterized in that a database is used which has been obtained in accordance with a method according to the invention for electronically and physically archiving documents.

A method for finding a physical document thus comprises the previously presented steps a) to e). The method can also comprise a step f), which describes the acts linked to finding a document. Step f) thus generally comprises a search query and the output of the search results, which can be implemented for example via a screen. Here, the link obtained in step d) is preferably used in order to facilitate the necessary search and recovery processes of documents already archived, as needed. At the time of the preceding archiving, each document is preferably allocated a position link which adapts to following documents. The position of the physical document relates here preferably to the position of a document within a stack. It can thus be ensured that documents, as required, can be found quickly on the basis of the provided position display.

The search of documents already archived is unexpectedly simplified in that, at the time of the preceding archiving, no special sorting has to be observed and documents can still be found a lot more quickly than with other comparable archiving systems (for example archiving in file folders), since the user is shown the position of a sought document in the document container.

Furthermore, provision can be made for documents to be searched with use of metadata, wherein the metadata is produced by an input of a user of corresponding information, by evaluation of text recognition of the file and/or by an intelligent allocation on the basis of other information.

The term metadata is understood to mean information that is used for the search and that enables access to the database. Accordingly, information contained in the document to be archived can also be included by this term within the scope of the present invention, however this term also includes information concerning this document that is not contained in the document itself, for example the unique container identification, the position information of the physical document, the archiving date, or the user who created this document. This information can be predefined here by the user. Furthermore, a software can be used in order to find terms or synonyms similar to the information input by the user. Furthermore, a software can carry out a search even without an explicit search entry by a user. This automatic search, which for example can be realized in the form of a background service on a server, can serve for example to generate status reports or recollection reports, which can be transmitted to the user. The transmission can be carried out, inter alia, in the form of an e-mail or an on-screen notification.

Furthermore, a full-text recognition can be carried out for extraction of the image information obtained in step a) and/or step b) of the archiving method. In a preferred embodiment, a full-text search can be provided on the basis of this text recognition. As a result of this embodiment, a search for or within a document can be significantly simplified, so that there is no need to decide at the time of archiving which information is required for further processing.

A module can preferably be used which independently implements a deadline management function. A module can thus, inter alia, extract information associated with deadlines, said information being provided by text recognition from the image data of a physical document, and can automatically generate corresponding search queries. An intelligent allocation can be provided for this purpose.

The information that can be used for these purposes includes, inter alia, the date of the time information, the document type (letter, reminder, invoice, etc.), deadlines, payment amounts and/or detectable and evaluable colors, color patterns or logos.

Here, semi-automatic methods, such as report functions, can also be used, which for example work to recover information contained in the physical documents with use of the methods presented above. A software can thus provide proposals for search queries, which can be confirmed by the user.

In a particular embodiment, anticipated values can be generated by the system so that the user receives a warning or a notification if an archiving expected by the system has not occurred by a certain moment in time. Here, patterns in the sense of repetitions can be detected when archiving documents which belong for example to a certain document group. By way of example, invoices relating to continuing obligations can be sent periodically. Telephone bills are thus generally sent once per month, and insurance bills once per quarter, every 6 months, or annually. This regularity can be detected in a particular embodiment of the system so that a corresponding message can be displayed to the user in the event of the absent archiving of an anticipated document.

Furthermore, provision can be made for the physical position of a sought physical document linked with an electronic document preferably found by a search query, preferably by inputting meta-information, to be calculated and for the physical position of the physical document to the output to the user via an output device, preferably via a presentation on a screen, particularly preferably on the screen of a computer, the smartphone, the tablet, or the digital camera, wherein the calculation is preferably made with the aid of a number of parameters, such as the total number of documents in the container and the associated identifier of the document.

The screen display here can present, for example, the position of the document in a vertical orientation relative to the stack, wherein this is implemented for example on the basis of a cutout provided in the container and/or on the basis of a schematic illustration of the container, in which the position of the document is illustrated by a horizontal line. Furthermore, the position of a document to be found can be presented with the display of a bar relating to a scale, for example a color scale, provided in the container. Here, an arrow can indicate the position of the physical document in the container. Furthermore, in particular in a further step, documents archived before or after the document to be found can be shown in order to facilitate browsing. This presentation can be both of two-dimensional or three-dimensional design, wherein, in a three-dimensional design, a number of documents can be shown in an overlapping manner. By way of example, the upper regions of the documents can preferably be visible. Here, an electronic turning can be implemented, possibly by simple swiping gestures, so that the user is provided with a simple overview of the physical documents provided in the archive, on the basis of which the user can find the sought physical document particularly easily.

Here, the visual presentation can be realized in the form of a single image schematically indicating the vertical position of a document. The vertical position of the document relates here to the position of a document in the stack direction of the container. Furthermore, a 3D graph or “augmented reality” view can be used in order to indicate the position of a physical document in a container.

In a particularly preferred embodiment a 3D visualization of the entire content of the container can be provided in order to facilitate the search for documents. In addition, a color scale can be used, which divides the content of the container into a number of portions. A document located in a certain portion is then also shown to the user in exactly this area during the search, which simplifies the recovery process in an unforeseeable way.

In a further embodiment of the method for finding a physical document, provision can be made for the physical document to be removed from the container and also returned to this container at any later moment in time, wherein the document is not filed at the previous position within the container, but is placed at the top of the document stack located in the container. The document can also be filed in another container which is already known to the system or which will be made known to the system.

Here, the system can comprise the examination and/or auxiliary functions discussed above in order to avoid operator errors. The system can thus generate a query as to whether a sought physical document has been removed and later returned if this information has not already been transmitted to the system by the user. Here, the user can communicate the container and the position. Furthermore, provision can be made for a document to be re-archived, in particular photographed, when returned, and for the system to automatically detect, on the basis of the text information based on a text recognition analysis, that this document has already been archived at an earlier moment in time. The system can preferably notify the user and request confirmation of this finding.

This embodiment simplifies the handling of the previously obtained archive in an unforeseeable way. Following the removal of a document, the container can thus be closed and put away as necessary, without the need to mark the point from which the document was removed from the container. When the document is returned to the box, the database must merely be informed that the document has been re-filed, i.e. at the top of the stack. The communication to the database can take place automatically, preferably by means of a default setting, or by user input. The structural organization of the archive can thus be maintained without the container having to remain for a long time in an open state.

A further subject of the present invention is a container for carrying out one or more of the previously described methods, wherein this container has at least one region in which the physical documents can be filed on top of one another. Accordingly, the container is designed such that the documents can form a stack. The format of the container is based here on the documents expected to be filed, wherein the base area for example is slightly larger than the conventional formats, such as DINA4 or DINA5. The height of the container here is likewise based on requirements, so that for example at least 20, preferably at least 100, and particularly preferably at least 300 documents can be filed. The maximum number of documents is not subject to a particular limit, wherein it may be advantageous that preferably at most 10,000, particularly preferably at most 5000, and especially preferably at most 1000 documents can be filed in the container. These values are based on a DINA4 sheet weighing 80 g/m², wherein the container can be closed without a specific exertion of force. The container is preferably designed so that it can be easily stored. By way of example, the container can be of a suitable size so that it can be stacked.

Furthermore, provision can be made for the container to have a support surface region on which the documents to be archived can be placed. This support surface region can be formed by a cover or a lid connected to the container. The support surface region can preferably have markings within which the physical document to be archived can be placed for digitization. This support surface region can also preferably have a peripheral elevation, which serves as delimitation and as a simple rest for the document to be archived. The surface of the support surface region on which the document to be archived is placed in order to record a digital image can preferably have a color or a color shade which leads to a high contrast. By way of example, this surface can have a particularly dark color shade so that the outline of the documents, which is usually kept white, can be clearly detected. This support surface region can particularly advantageously have a symmetrical pattern with light and dark regions, preferably a checkered or serpentine pattern which is black and white. The outline of light and dark documents can thus be clearly identified.

In a preferred embodiment this support surface region can comprise a smoothing device. This can be based on electrostatic charging or on a frame which can be placed in a flexible manner at least against part of the physical document to be archived. This frame can be provided in a preferred embodiment with a pattern and/or a color so that a high contrast is obtained. A smoothing device can also be provided by a glass plate to be applied, which is preferably highly anti-reflective.

When creating the archive, for example when capturing the file in step a) and/or when storing at least some information based on the file captured in step a) in an electronic memory according to step b), a software can preferably be used which comprises an automatic edge recognition, also referred to as edge detection. The edges of the document to be archived can thus be determined so that further functions of the software, for example an automatic warning function if the document has been incompletely photographed, are facilitated. Furthermore, as a result of an edge recognition, an improvement of the image optimization can be attained, for example a rectification of the document based on the fact that a document to be archived has a rectangular base area, such that the side delimitations are each parallel to one another. This can be performed, inter alia, by the algorithms presented above.

In a further embodiment of the present invention, the container can comprise a hinge mechanism, wherein the region in which the physical documents can be filed on top of one another is accessible in the open state of the hinge mechanism. This embodiment enables simple operation of the system and reliably prevents a support surface, which is preferably provided, from being separated from the container.

In accordance with a first embodiment, the hinge mechanism can be designed such that the support surface region when archiving at least two documents is moved between the above-presented steps a) and c) of the above-presented method for archiving documents. Furthermore, provision can be made preferably for the support surface region when archiving at least two documents to not be moved between the above-presented steps a) and c) of the above-presented method for archiving documents.

The container can preferably have a side wall which is hinged and which is fixed in the closed state by an edge region of a cover or a lid. Here, the upper side of the cover or the lid can be formed as a support surface region, as has been previously described. The cover can preferably likewise be hinged, so that the container comprises a total of at least two hinged regions which are fixedly connected to one another. A scale can preferably be provided in the interior of the container in the vicinity of the hinged side wall, on the basis of which scale a document can be found particularly easily.

The container can preferably comprise a second region in which documents likewise can be filed. In this second region, important documents, such as documents which have no expiry date, but must be stored over a particularly long period of time, can be filed particularly preferably. These include, among others, certificates and tax returns. The first region can be provided here for documents that are of importance only temporarily. By way of example, these include receipts, since these become insignificant once the guarantee has expired. Furthermore, the second region can be intended for physical documents that are required particularly frequently within a period of time. By way of example, certificates are needed in original form relatively often during an application period.

This second region can advantageously be provided as a compartment which is formed in the above-described support surface region. By way of example, the support surface region can be designed in the form of a sufficiently stable sleeve, similarly to an envelope, in which particularly important documents can be filed.

Furthermore, provision can be made for the container to have an attachment for supporting the camera, on which, in order to record an image of a document, the camera can be placed such that it maintains a predefined distance from the document, and which preferably has at least one sensor, via which a lighting means incorporated in the attachment where appropriate can be switched. This embodiment surprisingly facilitates the capture of documents to be filed, wherein a high, constant image quality can be ensured. This image quality facilitates an improvement of the file produced in step a) of the archiving method. The image information contained in the file can thus be subjected more easily to a rectification, edge smoothing and/or scaling.

In one embodiment the attachment for supporting the camera can be fixedly connected to the container for filing documents. This can be implemented for example by screws or the like, wherein a fixed connection is characterized in that it cannot be released without destruction, or tools are required in order to release the connection. Here, a support surface region, which is preferably provided and on which the documents to be archived can be placed, is disposed preferably within the container. In a further embodiment the attachment for supporting the camera can be releasably fitted, without a fixed connection being provided. Means can particularly preferably be provided which enable a releasable fixing of the attachment for supporting the camera. Here, these means can be formed for example by protuberances or notches in particular in the region of the cover of the container or of the lid of the container, for example a protruding edge. Magnets can particularly preferably be provided, which cause a releasable fixing of the attachment for supporting the camera to the container for filing documents.

In a preferred embodiment the attachment for supporting the camera is collapsible. Here, magnets can preferably be used so that the attachment can be made ready for use very easily. The attachment can be collapsed during storage so that the container can be stored in a space-saving manner.

In a preferred embodiment the container or part of the container in which the documents can be filed is stackable. If the container has an attachment for supporting the camera, this can preferably be dismantled or collapsed. Storage of many containers in a relatively confined space can thus be ensured. Furthermore, an attachment for supporting the camera can be dismantled from a used, in particular filled container and mounted on a new container.

The attachment for supporting the camera is preferably of such a size that allows storage within the container. Here, the attachment for supporting the camera can be fixedly or releasably connected to the container for the filing of physical documents, as has been presented above. Magnets are preferably provided in the cover of the container or in the lid of the container and in the attachment for supporting the camera, and prevent an accidental shifting or slipping of the attachment on the cover or the lid of the container.

In one embodiment, provision can be made for the attachment to have a support surface region, which preferably can comprise the above-presented features, for example a dark color for improving the contrast. Here, the support surface region provided in the attachment for supporting the camera can comprise a cutout, which can be designed such that a coded field applied to the container, preferably to the cover or the lid of the container, can be detected, which field in particular can be provided in the form of barcodes and/or QR codes and by means of which a container can be uniquely allocated. The cover is preferably connected inseparably to the container so that there is no risk of the containers becoming confused as a result of the covers being swapped.

The shape and size of this cutout is not critical, provided the stability of the attachment is ensured and the document to be archived can be filed expediently. By way of example, this cutout can be rectangular, wherein the support surface provided in the attachment can be of such a size that a document can be placed thereon in full. This cutout can be placed preferably directly above the coded field preferably attached to the cover or the lid of the container, for example a barcode or a QR code, so that an attachment can be used universally for other containers and a scanned document is allocated automatically to the corresponding container.

The attachment for supporting the camera has a region on which a camera can be placed so that the camera can record an image of a physical document. Elevations can preferably be provided, which enable a simple positioning of the camera, so that a particularly simple and secure support of the camera is ensured. These elevations can be releasably attached by adhesives and can be adapted to the size of a camera to be used. Furthermore, these elevations can be made of a soft material, for example of foam or of felt, which avoid damage to the camera as this is placed in position and which enable simple positioning and removal.

In a further embodiment of the present invention the container or part of the container in which the document can be filed is designed to be so stable that dispatch by means of a transportation company is possible. Furthermore, the container or part of the container in which the documents can be filed can be provided with an address fields so that the container or part of the container in which the documents can be filed can be forwarded to third parties, for example a tax adviser.

The container can preferably have a unique identification feature, which can be read using a camera via a communications interface. The method can thus be carried out particularly efficiently, wherein operator errors can be minimized. By way of example, a unique container identification can be transmitted to the database without intervention on the part of a user. With simultaneous use of a number of containers by a user, a confusion of the containers can thus be reliably avoided. Here, elements based on RFID, NFC, Bluetooth and/or W-Lan technology are possible communications interfaces. The camera can also be designed so that it can detect a coded field provided on the container, in particular in the form of barcodes and/or QR codes, which can be uniquely allocated to a container.

Provision can also be made for the container to have an electronic device with which the camera can be triggered automatically with production of a file by recording of a digital image. This embodiment has already been discussed in greater detail in conjunction with the archiving method, and reference is therefore made thereto.

A further embodiment is characterized in that the container has a cutout making it possible to view documents filed in the container. This cutout leads to unexpected advantages in particular when finding physical documents, since position information concerning the position of the document can be transmitted particularly easily hereby. The type of cutout is not critical per se, and therefore it can be rectangular, oval, or semi-circular. The position information concerning the position of a document to be found can also be expressed via a scale, which can be provided in the container, as discussed above. This embodiment can be linked advantageously to a display of disinformation on or in a screen. The scale can also be embodied in many different ways, wherein the division of the scale is dependent on the requirements of the particular application. The scale can thus be colored for example, wherein two, three or more different colors are presented, on the basis of which the position of a document can be easily illustrated. Furthermore, two, three or more different divisions can be provided on the basis of dashes, which can be provided with alphanumerical characters.

A further subject of the present invention is a computer program for executing one of the above-described methods. Here, the computer program can be formed as a web application, mobile application and/or native desktop application.

An electronic data storage medium or an electronic memory comprising a computer program for executing a method constitutes a further subject of the present invention.

In order to carry out the above-described methods, a single, portable camera can be used, which is provided with suitable hardware and software, wherein modern smartphones are generally equipped in this way. A system which is networked can preferably be used. Here, a camera, preferably a smartphone, can be networked to further computers via a connection, wherein the connection is preferably wireless. Conventional connection paths, for example the Internet, can be used here. This embodiment has the advantage, inter alia, that the data is still accessible via the Internet or corresponding data transmission paths should the camera be lost or damaged. Here, a data protection, also referred to as backup, can be implemented centrally without the individual user having to take care of this. The communication, in particular the communication via the Internet, can preferably be encrypted.

A network comprising at least one computer system can serve for the transfer, collection and aggregation of the data of different cameras, which are assigned to different users as appropriate. A network generally comprises at least one server, which can be connected to the particular camera via at least one data connection.

Accordingly, a camera is preferably provided with at least one data transfer unit, which is preferably based on one of the above-discussed wireless technologies, wherein this data transfer unit is operatively connected to a data memory so that data obtained by the camera can be transferred to an external computer system.

Furthermore, the data from the network can be made available to various users, in the case of a company for example to the accounting department and the departments responsible for order processing. Furthermore, the data can be provided to external companies, for example an accountant or a tax adviser.

The methods according to the invention and the container according to the invention are suitable in particular for use in private households and small to medium companies. These include, among others, craft and trade businesses and smaller service providers, who are obliged to store documents, but avoid audit-compliant electronic archiving systems for cost reasons.

Here, containers according to the invention can be provided with company identifying marks, logos or other labeling. The labeled containers can serve, among other things, as promotional gifts or can assist customers. By way of example, tax advisers can send containers to clients so that the clients of tax advisors archive the documents necessary for example for accounting using the present system and the tax adviser can deduce the information necessary for creating the accounts from the electronic archive created by the client.

Preferred embodiments of the present invention will be described hereinafter by way of example on the basis of nine drawings, without hereby limiting the invention. In the drawings:

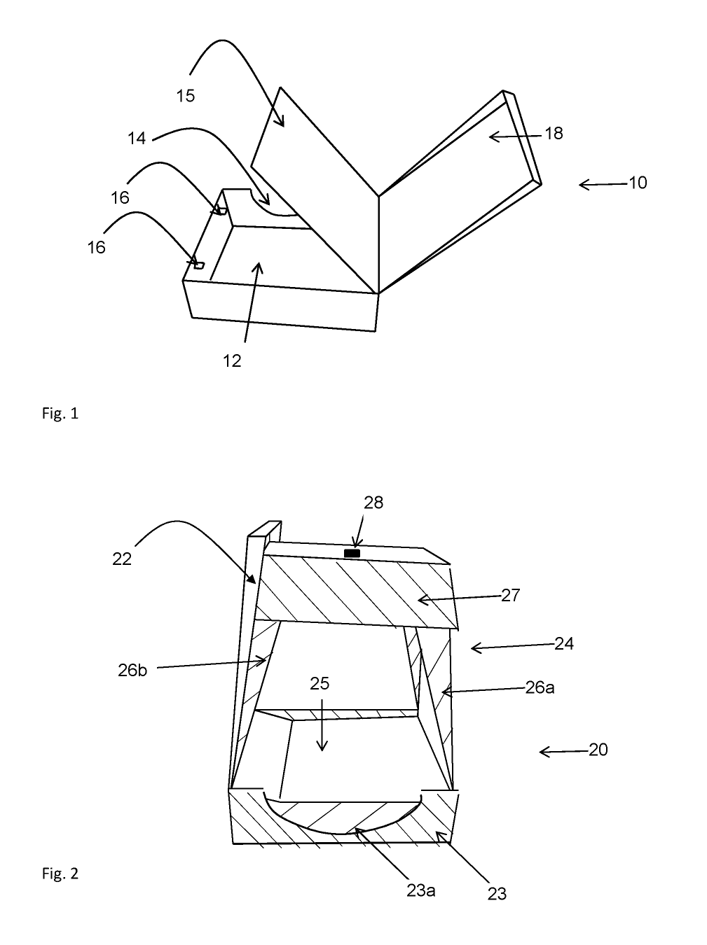

FIG. 1 shows a schematic perspective view of a container for carrying out the method,

FIG. 2 shows a further embodiment of a container according to the invention with an attachment for supporting the camera,

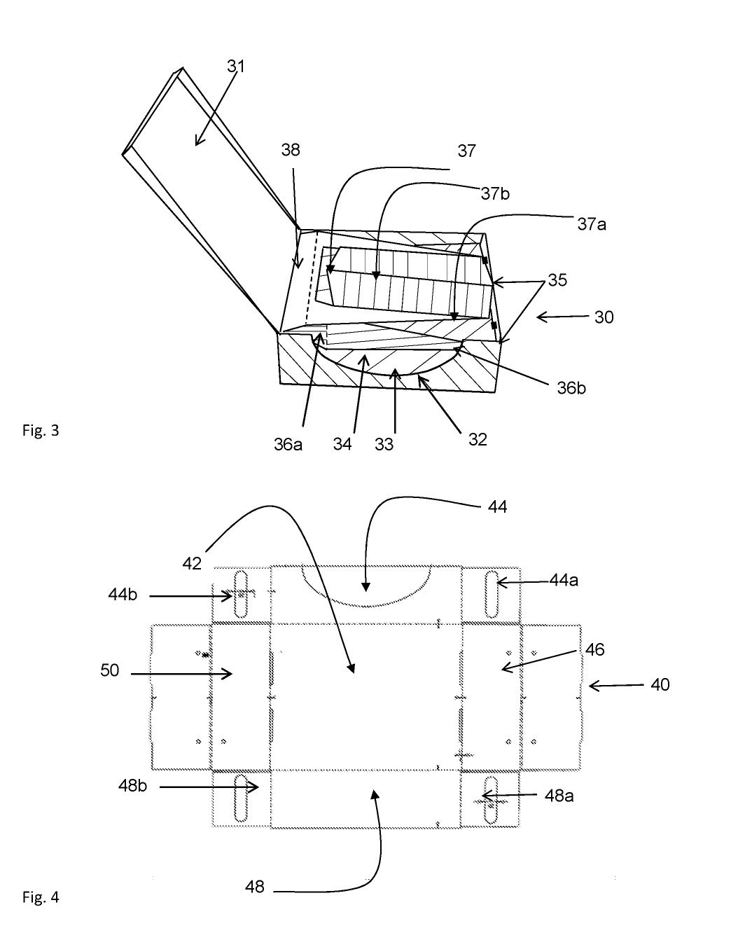

FIG. 3 shows a further embodiment of a container according to the invention with an attachment for supporting the camera, wherein the supporting rest has been collapsed,

FIG. 4 shows an unfolded box, from which a lower part for a container according to the invention can be produced,

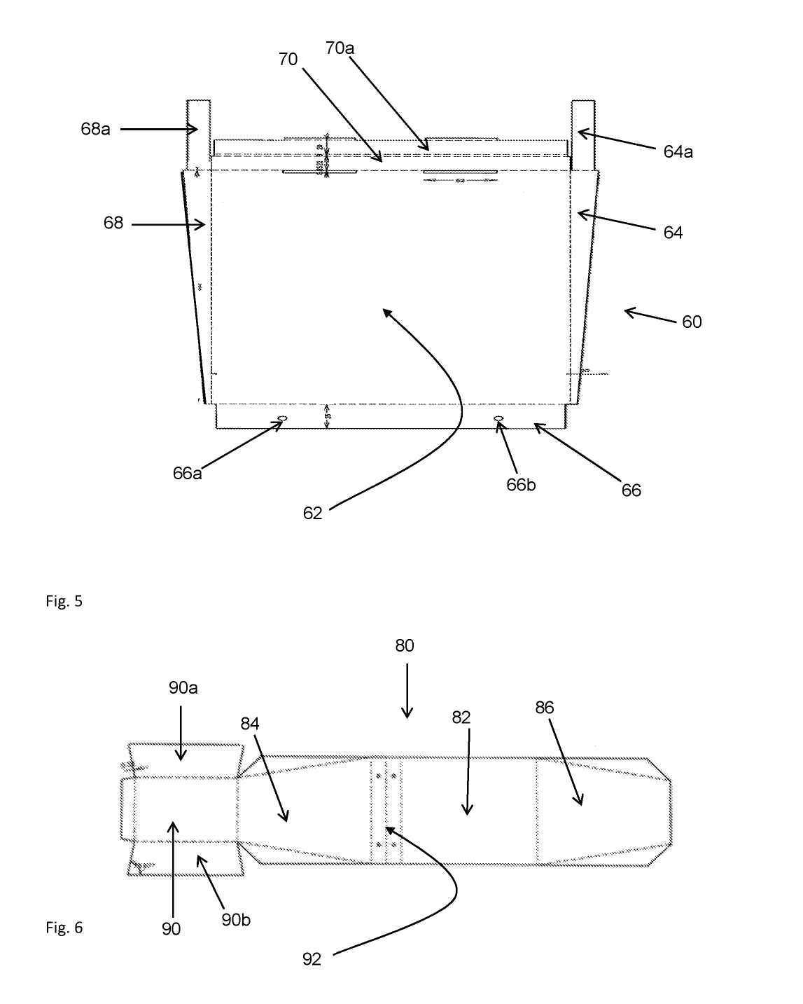

FIG. 5 shows an unfolded box, from which a cover for a container according to the invention can be produced,

FIG. 6 shows an unfolded box, from which an attachment for supporting the camera can be produced,

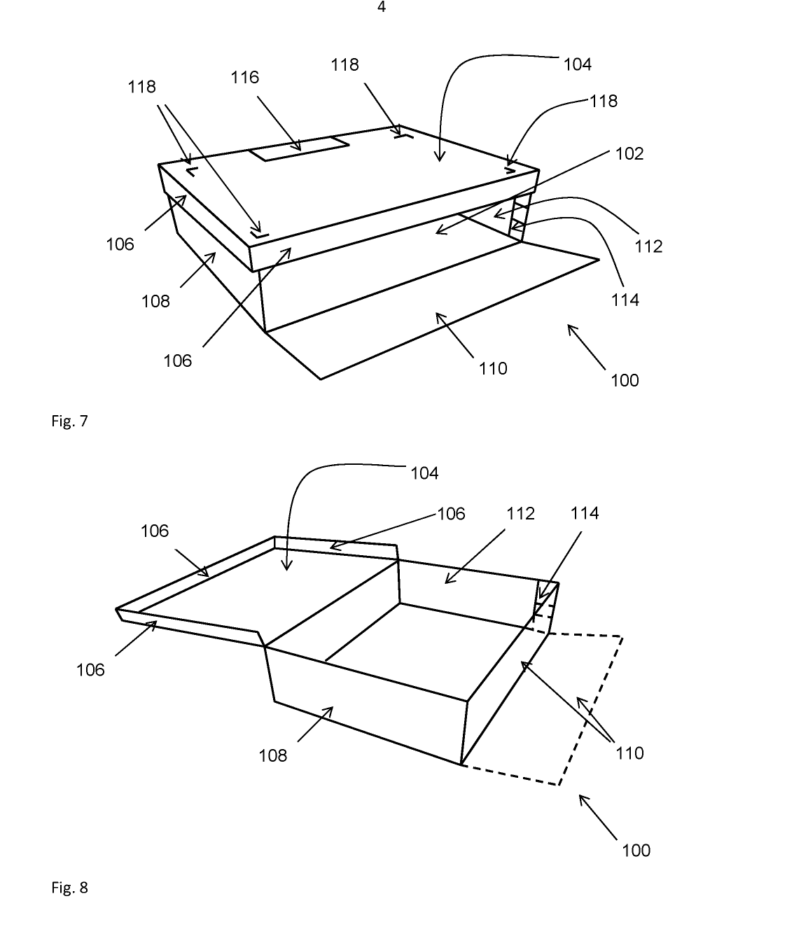

FIG. 7 shows a schematic perspective view of a further container for carrying out the method,

FIG. 8 shows a schematic perspective view of a further container for carrying out the method, wherein the cover is folded open,

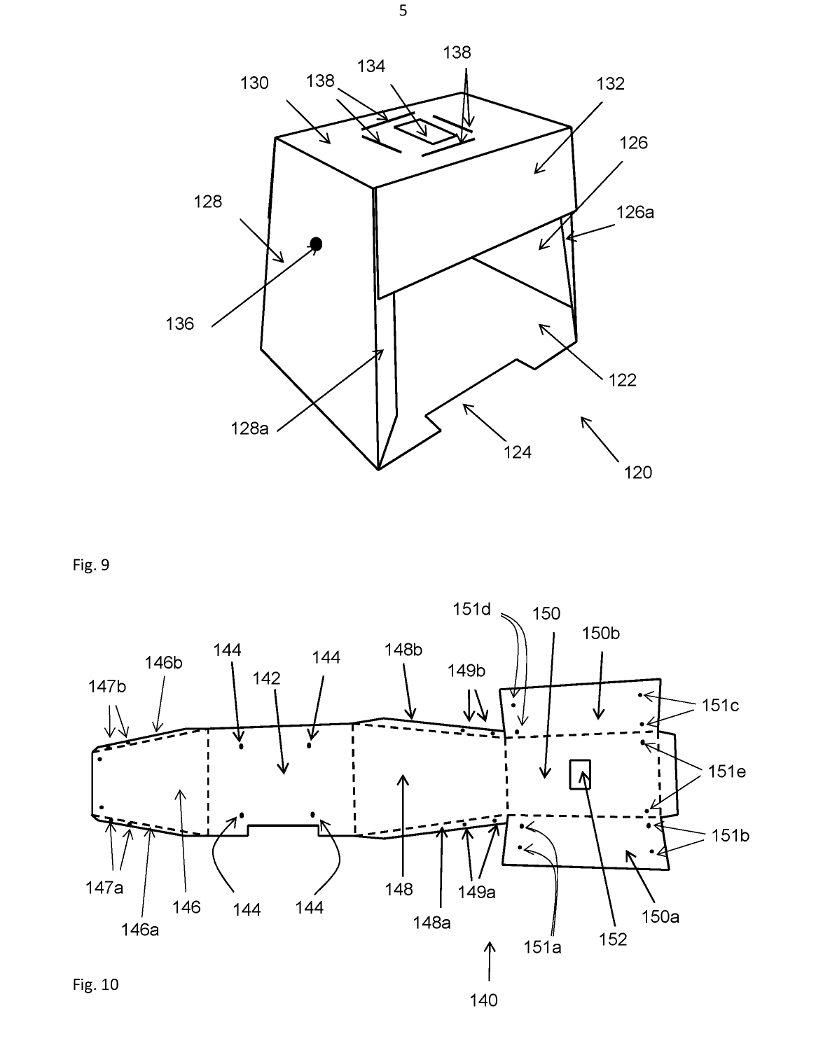

FIG. 9 shows a further attachment for supporting the camera,

FIG. 10 shows an unfolded box, from which an attachment for supporting the camera can be produced,

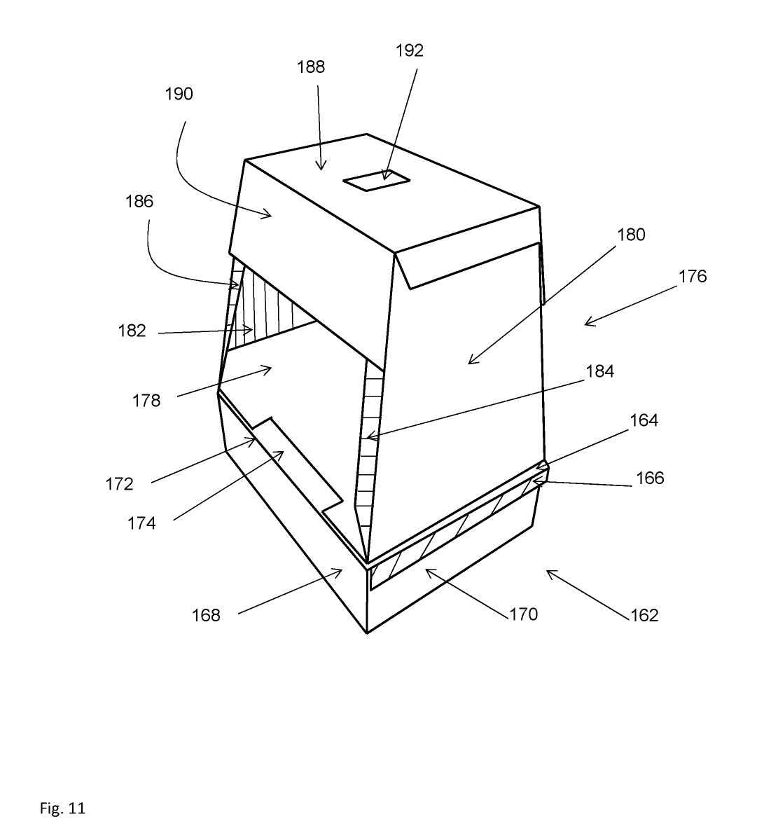

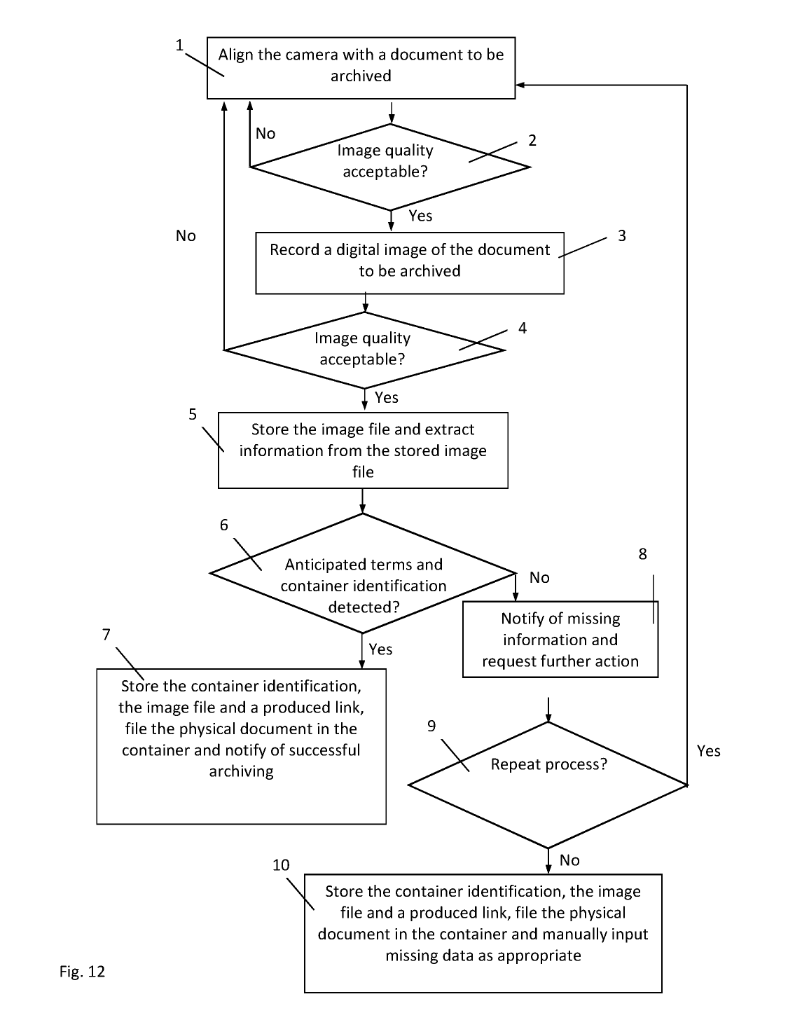

FIG. 11 shows a further embodiment of a container according to the invention with an attachment for supporting the camera,

FIG. 12 shows a flow diagram for an archiving process in accordance with a method according to the invention,

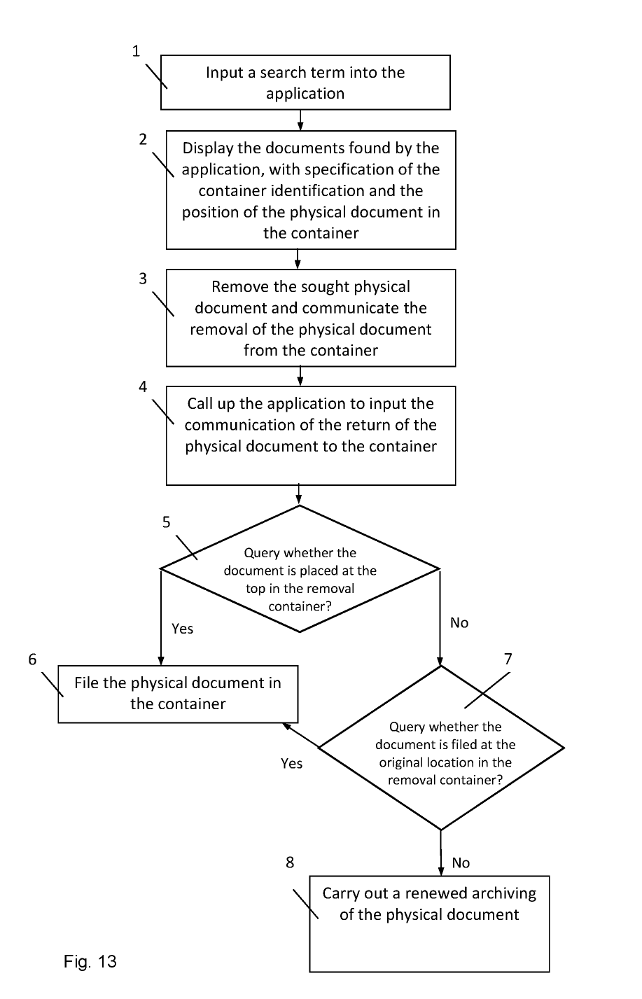

FIG. 13 shows a flow diagram for a search process in accordance with a method according to the invention,

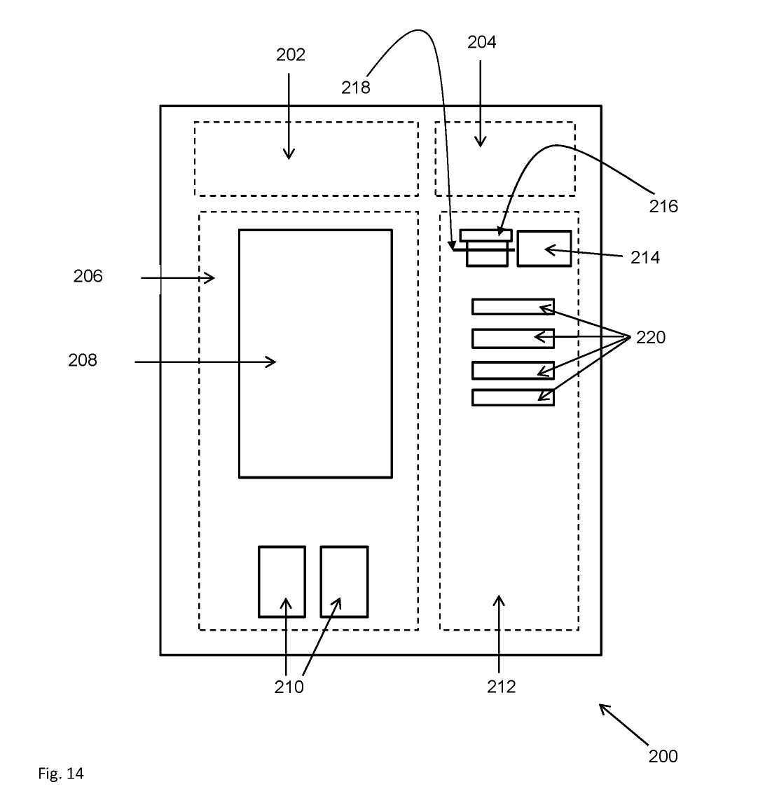

FIG. 14 shows a schematic view of a screen display for presenting search results, and

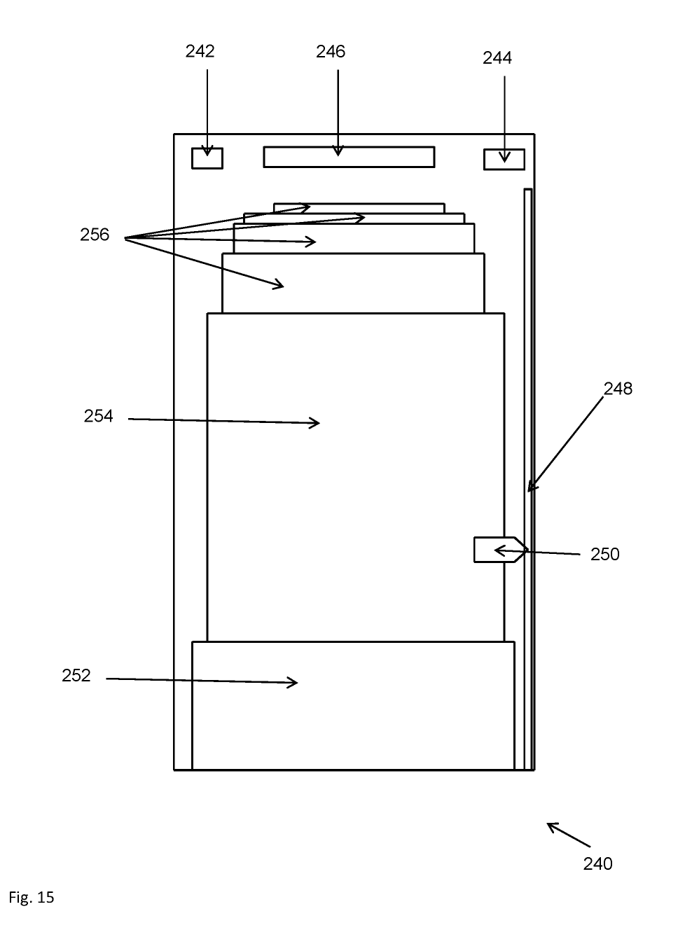

FIG. 15 shows a schematic illustration of a further screen display for presenting search results.

FIG. 1 schematically describes, in a perspective view, a preferred embodiment of a container (10) for carrying out the method. The container comprises a region (12) in which physical documents can be filed in a stackable manner. Here, the container has a cutout (14), which makes it possible to see documents filed in the container (10). The present embodiment of the cutout makes it possible for a movable, preferably hinged support surface region (15), on which the documents to be archived can be placed, to be moved particularly easily. Here, the support surface region can be secured to a side of the container, for example by screws (not illustrated). On the opposite side of the container (10), a protuberance (16) can be formed, such that a sufficiently stable support surface is formed. This protuberance (16) is provided in the present case in the form of two screws, however another embodiment, for example a cardboard fold, can also be expedient. In the present embodiment the support surface region (15) on one side of the container is screwed together with a cover (18), which likewise is hinged, on a side wall of the lower part of the container. In accordance with another embodiment, provision can be made for the support surface region to be placed on two protuberances which can be provided on at least two opposite sides of the side walls of the container. In the embodiment presented in FIG. 1, a peripheral elevation is formed by the part of the container in which the physical documents can be filed.

FIG. 2 shows a further embodiment of a container (20) according to the invention which likewise can have the properties presented above in conjunction with FIG. 1. The container can thus comprise, among other things, a cover (22) and a region (23) in which physical documents can be filed in a stackable manner, wherein a cutout (23a) is provided so that documents filed in the region (23) are visible. This embodiment of the container additionally comprises an attachment for supporting the camera (24). This attachment comprises a support surface region (25), on which documents to be archived can be placed. The attachment (24) also comprises two side walls (26a) and (26b), which are collapsible, and also a supporting rest for a camera (27), in which an opening (28) is provided, through which a camera can record an image of a physical document resting on the support surface region (25) discussed above.

FIG. 3 shows a further embodiment of a container (30) according to the invention, which likewise can have the properties discussed above in conjunction with FIGS. 1 and 2. This container can thus comprise, among other things, a cover (31) and a region (32) in which physical documents can be filed in a stackable manner. In addition, it can be deduced from this illustration that the attachment for supporting the camera (33) can be collapsible, wherein the support surface region (34) rests at an end face on two protuberances (35), which for example can be formed by screws. The side walls (36a) and (36b) rest on the support surface region (31), wherein two side parts (37a) and (37b) of the supporting rest for a camera (37) can be seen. FIG. 3 also shows a preferred embodiment of a hinge mechanism of a cover (31), which in the present case is formed by a fold (38) in combination with a stable fastening of the cover (31) to a region (32) in which physical documents can be filed in a stackable manner.

FIG. 4 shows an unfolded box (40), from which a lower part for a container according to the invention can be produced, in particular a region in which physical documents can be filed in a stackable manner. Here, the dashed lines constitute the points at which the box (40) can be folded in order to form the region in which physical documents can be filed in a stackable manner. Here, a base can be formed from the base region (42) and the side faces can be formed from the side regions (44), (46), (48) and (50). In the present embodiment the side regions (44) and (48) each have prepared fold lines so that side regions (44a) and (44b) or side regions (48a) and (48b) are formed, via which the side regions (44) and (48) can be connected to the side regions (46) and (50). In the present embodiment the side regions (46) and (50) also have prepared fold lines so that part of the side regions (46) and (50) can be folded over the side regions (44a) and (44b) or the side regions (48a) and (48b). In the illustrated embodiment the side face regions each have openings, by means of which the side regions (44), (46), (48) and (50) can be connected to one another in a stable manner via screws.

FIG. 5 shows an unfolded box (60), from which a cover for a container according to the invention can be produced. Here, the dashed lines constitute the points at which the box (60) can be folded to form the cover. Here, a lid can be formed from the lid region (62) and the side faces can be formed from the side regions (64), (66), (68) and (70). Openings (66a) and (66b) can be provided on a side face, in the present case the side region (66), by means of which openings the side region (66) can be screwed to a matching side region of the lower part of the container in which physical documents can be filed in a stackable manner. In the present embodiment, fold lines are provided in side regions (64), (68) and (70) so that the sub-regions of the side regions (64a), (68a) and (70a) can be folded over one another in order to form a stable edge.

FIG. 6 shows an unfolded box (80), from which an attachment for supporting the camera can be produced. Here, the dashed lines constitute the points at which the box (80) can be folded in order to form the attachment. Here, a support surface region, on which the documents to be archived can be placed, can be formed from the region (82). The regions (84) and (86) form the side faces of the attachment, whereas the region (90) forms a rest for supporting the camera. Here, the regions (90) and (86) can be releasably held together via magnets or hook-and-loop fasteners so that a stable support surface is formed. Once an image has been recorded, the regions (90) and (86) can be released from one another so that the entire attachment can be collapsed. The region (90) comprises two further fold lines so that side parts (90a) and (90b) can be formed, which additionally stabilizes the supporting rest for a camera. In the present embodiment, three fold lines are provided between the regions (84) and (82) so that a region (92) is formed. In this region, four openings are provided, by means of which the region (92) can be connected in a stable manner, for example using screws, to a matching side region of the lower part of the container in which physical documents can be filed in a stackable manner.

FIG. 7 schematically describes, in a perspective illustration, a preferred embodiment of a further container (100) for carrying out the method. The container comprises a region (102) in which physical documents can be filed in a stackable manner. Here, the container has a movable, preferably hinged cover (104), which can serve as a support surface region, on which the documents to be archived can be placed. In the present embodiment the cover (104) has, on three sides, an overhang (106) so that three of the side walls (108, 110, 112) are covered at least in part in the folded state. One of the side walls (110) of the container, in the present case a longitudinal side, is foldable in the illustrated embodiment. During an archiving process, this side wall (110) can remain unfolded so that a number of documents can be archived and can be filed in the container (100) without this side wall (110) having to be moved. In the folded state of the side wall (110), this is fixed by the overhang (106) of the cover (104) so that a closed container (100) has sufficient stability. The container (100) illustrated in FIG. 7 has a scale (114), on the basis of which the position of an archived document can be easily found. Magnets or materials, in particular metals, which can be fixed by magnets can be provided in the cover of the container. An attachment for supporting a camera can thus be releasably secured against accidental shifting or slipping. In addition, the container can have one or more coded fields (116), in particular in the form of barcodes and/or QR codes, which facilitate an automatic allocation during the archiving process of a file to a container (100). The cover can also be provided on the upper side with markings (118) which illustrate on the cover the position of a document to be archived.

FIG. 8 schematically describes, in a perspective illustration, a preferred embodiment of a further container (100) for carrying out the method. The reference signs illustrated in FIG. 8 have the same meaning as the corresponding signs illustrated in FIG. 7. Here, the container (100) presented in FIG. 7 is illustrated in a state in which the cover (104) is folded open so that the overhangs (106) provided on three sides are clearly visible. The foldable side wall (110) is also folded upwardly so that it is clear that the cover in the state folded closed can secure this side wall. The unfolded state of this side wall (110) is also illustrated in a dashed manner.

FIG. 9 shows a further attachment for supporting the camera (120). This attachment (120) comprises a support surface region (122), on which the documents to be archived can be placed. The support surface region (122) can be provided preferably on the underside with magnets, which allow a releasable fixing of the attachment for supporting the camera (120). The present support surface region (122) also comprises a cutout (124) so that a coding applied to the container, in particular a barcode or a QR code, is visible. The present attachment (120) also comprises two side walls (126) and (128), which are foldable and which each have two movable tabs (126a) and (128a), which support a supporting rest for a camera (130). The two movable tabs (126a) and (128a) of the side walls (126) and (128) are connected to tabs (132) which are provided on the supporting rest for a camera (130), wherein this embodiment can be better seen in FIG. 10. An opening (134) is provided in the supporting rest for a camera (130), through which opening a camera can record an image of a physical document resting on the previously described support surface region (122). For improved illumination, the attachment for supporting the camera (120) can be provided with a lighting means (not illustrated), which for example is secured to one of the two side walls (126) and (128) or to the supporting rest for a camera (130). The lighting means can be switched via a switch, wherein the switching can be performed manually or via a sensor which can cooperate with the camera, preferably a smartphone. Here, the lighting means can be supplied with power via a primary battery or a rechargeable battery. Furthermore, the lighting means can be connected to a plug socket via a cable, wherein in FIG. 9 a corresponding bore for a cable (136) is visible. Furthermore, elevations (138) can be provided on the supporting rest for a camera (130) and enable a simple positioning of the camera so that the camera can be supported in a particularly simple and secure manner. These elevations can be releasably attached by adhesives and can be matched to the size of a camera to be used.

FIG. 10 shows an unfolded box (140), from which an attachment for supporting the camera can be produced. The dashed lines here constitute the points at which the box (140) can be folded in order to form the attachment. Here, a support surface region, on which the documents to be archived can be placed, can be formed from the region (142). The regions (146) and (148) form the side faces of the attachment, whereas the region (150) forms a supporting rest for placement of the camera. The region for forming a rest for supporting the camera (150) has a cutout (152), which forms an opening through which a camera can record an image of a physical document. Here, the regions (146) and (148) can be releasably held together via magnets or hook-and-loop fasteners so that a stable support surface is formed. Once an image has been recorded, the regions (146) and (148) can be released from one another so that the entire attachment can be collapsed. The region (142) can comprise magnets or materials, in particular metals, which can be fixed by magnets, which stabilize the attachment on the container with respect to accidental movements and ensure that the attachment is fixed in an optimal position with respect to the container so that optical codings, for example barcodes or QR codes, can be fully detected. An embodiment for placement of the magnets is shown by way of example in FIG. 10. The magnets (144) or corresponding materials can thus serve for releasable connection to the container in the region (142) from which a support surface region can be formed. The magnets (147a, 147b) provided in the tabs (146a) and (146b) to support the region (150) serving to form a supporting rest for supporting a camera can cooperate in particular with the magnets (151b) and (151c) provided in the tabs (150a 150b) of the region (150) serving to form a rest for supporting a camera. Accordingly, the magnets (151a) and (151d) also provided in the tabs (150a, 150b) of the region (150) serving to form a rest for supporting a camera can cooperate with correspondingly placed magnets (149a) and (149b) of the tabs (148a) and (148b), which are provided in the region (148) from which a side wall can be formed.

FIG. 11 shows a further embodiment of a container (162) according to the invention with an attachment (176) which can likewise have the properties discussed above in conjunction with FIGS. 7, 8, 9 and 10. The container (162) can thus comprise, inter alia, a cover (164) and a region in which physical documents can be filed in a stacked manner. The cover (164) has, on three sides, overhangs (166). The container (162) also comprises side walls (168, 170), wherein the cover (164) is connected to a side wall (168) in a hinged manner so that a movable connection (172), which can be referred to as a folding edge, is formed. The container also comprises a coded field (174) which can contain optical codings, for example barcodes or QR codes. The container (162) is provided with an attachment (176), which has a support surface region (178), on which the documents to be archived can be placed, wherein a cutout is provided in this support surface region so that the coded field (174) provided on the cover (164) of the container (162) is visible. In addition, two side walls (180, 182) each having two tabs (184, 186) are provided in the attachment and support the support surface for supporting a camera (188), wherein the tabs (184, 186) of the side walls (180, 182) are releasably connected to the tabs (190) of the support surface for supporting the camera. The support surface for supporting a camera (188) has an opening (192), through which a camera can record an image of a physical document resting on the support surface region (178) described above.

FIG. 12 shows a flow diagram for an archiving process in accordance with a method according to the invention. In step 1 of the method, a camera is aligned with a physical document to be archived. The camera is preferably designed, in particular programmed with software, so that here the image quality is automatically detected. This quality by way of example can include an edge recognition so that the user is requested via a warning or auxiliary function to move closer to the document or to provide a greater distance between the camera and document. By way of example, the document can also be focused. The examination as to whether a predefined image quality is achieved is performed in decision step 2. If the image quality is too poor, step 1 can be carried out again. With sufficient quality, a digital image of the document to be archived is recorded in accordance with step 3, wherein, in the present embodiment, the image quality obtained is checked in decision step 4. This can be performed by means of conventional algorithms or manually, for example by means of a query displayed on a screen.

If the image quality does not meet the requirements, a new image is recorded, starting with step 1. With sufficient image quality, an image file is stored in step 5 and information is preferably extracted from the image file, for example by means of text recognition. In this step, a QR code attached to the support surface and which comprises unique container information can be detected, for example. This process can be performed in the camera or a computer system connected to the camera, wherein the connection can also be established via the Internet. In decision step 6, it is checked whether anticipated terms, for example keywords such as invoice, order, insurance policy, etc. and container information have been detected.

If anticipated terms, for example keywords such as invoice, order, insurance policy, etc. have been detected, the image file produced in step 3 and/or part of the information extracted in step 5 can be stored together with a unique container identification and/or position information of the physical document in the container and together with an associated link, and the physical document can be filed in the container in accordance with step 7. A notification regarding successful archiving can then be output to the user, in which notification the detected data regarding the document to be archived can be contained.

If, in decision step 6, it is determined that none of the anticipated terms can be found, a corresponding notification can be transmitted to the user in step 8, wherein the user can decide in accordance with decision step 9 whether the archiving process should be repeated or whether the physical document should be filed in the container. In the case of repetition of the archiving, step 1 is carried out again. Otherwise, the document is placed in the container in accordance with step 10 and the obtained data is stored together with a unique container identification and/or position information of the physical document in the container and together with an associated link. Absent data can be entered manually into the system as appropriate.

FIG. 13 shows a flow diagram for a search process in accordance with a method according to the invention. In step 1 of the method a search term is input into the corresponding application. The documents found by the application are displayed in step 2, with specification of the container identification and the position of the physical document in the container. The sought document can then be physically removed, wherein the removal of the physical document from the container can be communicated to the system. This can occur in an automated manner so that, after a search, at the moment of completion, the application displays whether the document last displayed on the screen following a search was removed. A corresponding input can also be made by the user.

The document removed from the archive can be returned in accordance with step 4. For this purpose, in accordance with step 4, the application can be called up, wherein the application can automatically display the previously removed documents and the user can select the corresponding document via an input. Furthermore, the user can also input a document identifier, for example the name of the document.

In decision step 5 it is possible to query whether the document is placed at the top of the stack of the removal container. If this is confirmed, the document can be filed at the corresponding point in the container in accordance with step 6.

If the query in accordance with decision step 5 was answered in the negative, it is possible to query in decision step 7 whether the document is filed at the original location in the removal container. If this is confirmed, the document can be filed at the corresponding point in the container, as is illustrated in step 6.

If this query is answered in the negative, a renewed archiving of the document can be carried out in accordance with step 8 in order to add the document to the archive, as has been presented in detail in FIG. 12. Here, previous information regarding the document can be adopted from the database so that in particular the container identification and/or the position information of the physical document in the container and also the associated link can be newly created and stored in the subsequent renewed archiving.

FIG. 14 shows a schematic illustration of a screen display for presenting search results. In the present embodiment the screen is divided into four areas (202), (204), (206) and (212), wherein the information presented in these areas (202), (204), (206) and (212) can also be provided in a different arrangement or only in part. This can be expedient for example with use of smartphones having a small display, and these areas (202), (204), (206) and (212) can thus be controlled via menus, for example.

In the area (202), a name of the found document can be displayed, whereas in the area (204), a container name can be presented. The container name can be identical to the unique container identification stored in the system, but can also be predefined by the user. In the area (206) arranged below the area (202) in the present case, a page of the found document (208) can be presented, wherein further pages of the document (210) can be schematically shown in a preview illustration in the lower part of the area (206). In the area (212), which in the present case is arranged below the area (204) and next to the area (206), the position of the found document can be presented in the display field (214). By way of example, it can be presented in the display field (214) that the found document is filed at position 117 of 200 previously entered documents. This is represented by the schematically illustrated container (216) together with a displayed horizontal line (218), wherein the horizontal line reflects the approximate vertical position of the physical document.

The names of the documents found during a search and/or of the documents filed before or after the found document in the container can be presented in display fields (220).

FIG. 15 shows a schematic illustration of a further screen display for presenting search results. This screen presentation comprises two fields (242, 244) for controlling the program and a field for displaying the container name (246). Furthermore, a vertically arranged bar (248) is visible and refers to the scale provided in a container. If, for example, a color scale should be provided in the container, the bar can thus have a corresponding color coding. An arrow (250) marks the vertical position of the found document in the corresponding container. In this illustration, documents are visible in an overlapping manner in a three-dimensional view, wherein a document (252) above the found document (254) and various documents (256) below the found document are illustrated in part.

The display illustrated in FIG. 15 can be combined with further screen displays. These include for example a list-like presentation of various results of a search which all meet the predefined criteria. A complete preview or a partial preview in a display can also be presented for each hit, wherein this display and the list display can be linked to a presentation regarding details of a search result. By way of example, information relating to specifications regarding date data, for example the date of creation, and the document type (letter, reminder, invoice, etc.) of a document can be contained in the presentation relating to details of a search result. All of these displays can be linked to the screen display illustrated in FIG. 15 via button areas provided via a touch-sensitive screen.

The features of the invention disclosed in the above description and in the claims, drawings and exemplary embodiments can be essential, either individually or in any arbitrary combination, to the realization of the invention in its various embodiments.

1. A method for electronically and physically archiving documents, said method having the following steps:
a) producing a file by a recording a digital image of the physical document using a camera;
b) storing at least some information based on the file captured in step a) in an electronic memory;
c) filing the captured physical document in a container or in one of a number of containers provided for the physical filing of the documents to be archived;
d) linking a unique container identification and/or position information of the physical document in the container with the file produced in step a) and/or the information stored in an electronic memory in step b), and
e) storing, in a database, the file produced in step a) and/or the information stored in an electronic memory in step b) with the link obtained in step d).

2. The method according to claim 1, comprising archiving a number of physical documents with production of a file, wherein each file is linked to an identifier and is stored in the database, wherein the identifier is produced by an input of a user, by evaluation of text recognition of the file and/or by an intelligent allocation on the basis of other information.

3. The method according to claim 1, comprising using a digital camera, a smartphone with camera, a tablet with camera, or a scanner as the camera.

4. A method for finding a physical document, comprising using a database obtained in accordance with a method according to claim 1.

5. The method according to claim 4, comprising searching documents with use of metadata, wherein the metadata are produced by an input of a user of corresponding information, by evaluation of text recognition of the file and/or by an intelligent allocation on the basis of other information.

6. The method according to claim 4, comprising calculating a physical position of a sought physical document linked with an electronic document and outputting the physical position of the physical document to the user via an output device.

7. The method according to claim 4, comprising removing the physical document from the container and returning the physical document to the container at an arbitrary later moment in time, wherein the document is not filed in the previous position within the container, but is placed at the top of the document stack located in the container.

8. A container for carrying out a method according to claim 1, wherein the container has at least one region in which the physical documents can be filed on top of one another.

9. The container according to claim 8, wherein the container has a support surface region, on which the documents to be archived can be placed.

10. The container according to claim 8, wherein the container has a hinge mechanism, wherein, in an open state of the hinge mechanism, the region in which the physical documents can be filed on top of one another is accessible.

11. The container according to claim 8, wherein the container has an attachment for supporting the camera, on which the camera can be placed to record an image of a document such that said camera maintains a predefined distance from the document.

12. The container according to claim 8, wherein the container has a unique identification feature, which can be read using a camera via a communications interface.

13. The container according to claim 8, wherein the container has two hinge mechanisms so that the cover and a side wall, which is opposite the movable fastening of the cover, are connected to the container in a hinged manner.

14. A computer program for executing a method according to claim 1.

15. An electronic data storage medium or electronic memory comprising a computer program for executing a method according to claim 1.

16. The method according to claim 2, wherein the identifier is produced by evaluation of text recognition of the file.

17. The method according to claim 1, comprising using a mobile device with a camera as the camera.

18. The method according to claim 6, comprising finding the sought physical document by means of a search query by inputting meta-information, and outputting the physical position of the physical document to the user via a presentation on the screen of a computer, the smartphone, the tablet, or the digital camera, and making the calculation with the aid of a number of parameters, including the total number of documents located in the container and the associated identifier of the document.

19. The container according to claim 11, wherein the container has at least one sensor, via which a lighting means incorporated in the attachment where appropriate can be switched.
